(19) United States
(12) Patent Application Publication
(10) Pub. No.: US 2023/0043413 A1
(43) Pub. Date: Feb. 9, 2023

(54) ANTI-SLIP FLOOR TILE FRAME WITH TILES AND METHOD OF MAKING AN ANTI-SLIP FLOOR TILE

(71) Applicant: Traction Technologies Holdings, LLC, Detroit, MI (US)

(72) Inventors: William R. DAVIDSON, Brookings, SD (US); Jeffrey R. BAKER, Clinton Township, MI (US)

(21) Appl. No.: 17/882,398

(22) Filed: Aug. 5, 2022

Related U.S. Application Data
(60) Provisional application No. 63/230,177, filed on Aug. 6, 2021.

(51) Int. Cl. E04F 15/022; E04F 15/02; E04F 15/06; E04F 15/08

(52) U.S. Cl. CPC E04F 15/022; E04F 15/02172; E04F 15/06; E04F 15/082; E04F 15/02188

(57) ABSTRACT

A floor tile is disclosed that includes a metal framework that supports a plurality of tiles. The metal framework defines recesses having a depth D that are separated by ridges. The ridges are coated with an anti-slip coating. The tiles are each assembled into one of the recesses. The tiles have a height H that is less than D and a top surface that is recessed below the anti-slip coating on the ridges. Methods for making and installing the floor tile are disclosed that includes the steps of applying an anti-slip coating to an upper surface of a metal framework. Assembling a plurality of tiles into the recesses. An adhesive is applied between the tiles and the recesses to secure the tiles with the top surface of the tiles being recessed relative to the ridges. The floor tile is installed on a floor with an adhesive.

### REFERENCE TO RELATED APPLICATIONS

This application claims the benefit of U.S. provisional application Ser. No. 63/230,177 filed Aug. 6, 2021, the disclosure of which is hereby incorporated in its entirety by reference herein.

### TECHNICAL FIELD

This disclosure is directed to a method of making an anti-slip floor tile and the floor tile made by the method.

### BACKGROUND

Floor tiles are used in a wide variety of applications and are used for their aesthetic appeal, durability, and ease of installation. Floor tile products may be made of ceramic, glass, granite, marble, wood and other hard surface materials. One problem with such floors is that they may become slippery when wet when used in areas such as building lobbies or commercial kitchens. These types of flooring applications are frequently exposed to surface hazards such as water and spilled food, beverages, and cooking products.

This disclosure is directed to solving the above problems and other problems as summarized below.

### SUMMARY

One aspect of this disclosure, a floor tile is provided that comprises a metal tile support panel and a plurality of tiles. The metal tile support panel has a top surface including a plurality of intersecting ridges, or raised portions, in the top surface that are coated with an anti-slip coating. The tiles are attached to the metal tile support panel between the plurality of ridges with an upper surface of the tiles being recessed below the top surface of the ridges in an installation orientation.

The plurality of tiles may be ceramic tiles, glass tiles, granite tiles, marble tiles, or wood tiles.

The metal tile support panel is preferably made of aluminum, or an aluminum alloy, but may also be formed of another metal such as stainless steel, steel, copper, brass, or the like. The anti-slip coating is preferably stainless steel or a stainless steel alloy but may also be formed of another metal.

The plurality of tiles may be attached to the tile support panel by an adhesive.

The metal tile support panel may define openings that extend from a bottom surface of the metal tile support panel to the top surface between the plurality of ridges and below the tiles.

The intersecting ridges may be provided in many configurations and may be rectilinear or may be curved.

The anti-slip coating may be a metal coating that is melted and sprayed on the plurality of intersecting ridges. The anti-slip coating is a metal coating that is metalized (applied by plasma stream deposition) on the plurality of intersecting strips. The anti-slip coating may be applied by other metal-on-metal application techniques provided that the coating provides a textured surface.

According to another aspect of this disclosure, a floor tile comprising a metal framework having a plurality of recesses, and a plurality of tiles disposed in the recesses. The plurality of recesses have a depth D that are separated by a plurality of intersecting ridges in the top surface that are coated with an anti-slip coating. The plurality of tiles are each assembled into one of the plurality of recesses and have a height H that is less than D, a top surface of the tiles is recessed below the anti-slip coating.

The floor tile may further comprise an adhesive applied between the plurality of recesses and the tiles that bonds the tiles into the recesses.

The floor tile may define an opening in at least some of the plurality of recesses that extend from a bottom surface of the metal framework to a top surface of the recesses.

The floor tile may include an adhesive applied to the bottom surface of the metal framework that is adapted to flow into the openings defined by the recesses.

The intersecting ridges may be provided in many configurations and may be rectilinear or may be curved.

According to another aspect of this disclosure, a method of making a floor tile is disclosed that is manufactured by the steps of providing a metal framework defining a plurality of recesses, and applying an anti-slip coating to an upper surface of the metal framework. A plurality of tiles are each assembled into one of the plurality of recesses. An adhesive is applied between the metal framework and the tiles to secure the tiles in the openings with the top surface of the tiles being recessed relative to an upper surface of the recesses in the metal framework.

The method of making a floor tile may further comprise stamping the plurality of recesses in the metal framework. The method may also include the step of forming at least one opening in at least some of the plurality of recesses of the metal framework.

The above aspects of this disclosure and other aspects will be described below with reference to the attached drawings.

### BRIEF DESCRIPTION OF THE DRAWINGS

FIG. 1 is a perspective view of a floor tile made according to one embodiment of this disclosure.

FIG. 2 is an exploded perspective view of a floor tile frame and a plurality of tiles aligned with recesses formed in the floor tile frame.

FIG. 3 is a top plan view of a floor tile frame that has an anti-slip coating applied to a top surface.

FIG. 4 is a top plan view of a floor tile including the coated floor tile frame shown in FIG. 3 and also including tiles disposed in recesses formed in the floor tile frame.

FIG. 5 is a cross-section taken along the line 5-5 in FIG. 4.

FIG. 6 is an exploded perspective view of a floor tile frame and a plurality of tiles aligned with recesses defining an opening formed in the floor tile frame according to another embodiment of this disclosure.

FIG. 7 is a top plan view of a floor tile frame as shown in FIG. 6 that has an anti-slip coating applied to a top surface.

FIG. 8 is a top plan view of a floor tile including the coated floor tile frame shown in FIG. 7 and also including tiles disposed in recesses formed in the floor tile frame.

FIG. 9 is a cross section view taken along the line 9-9 in FIG. 7.

FIG. 10 is a cross section view taken along the line 10-10 in FIG. 8.

FIG. 11 is a flow chart illustrating the steps of a method of making and installing the floor tile shown in FIGS. 1-10

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale, and some features may be exaggerated or minimized to show details of particular components. The specific structural and functional details disclosed are not to be interpreted as limiting, but as a representative basis for teaching one skilled in the art how to practice the disclosed concepts.

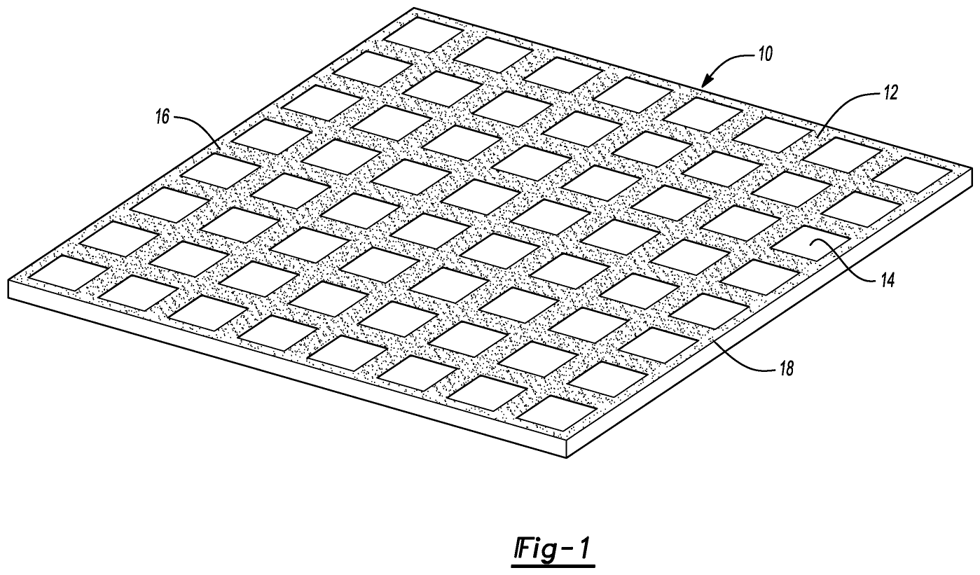

Referring to FIGS. 1-5, a floor tile assembly 10 is illustrated in FIG. 1 that includes a metal framework 12 (hereinafter “framework”) and a plurality of tiles 14. The framework 12 may also be referred to as a metal tile support panel. The tiles 14 are assembled to the framework 12 and permanently affixed with an adhesive (not shown) applied between the framework 12 and the tiles 14. An anti-slip coating 16 is applied to the framework by spraying molten metal on an upper surface 18 of the framework 12. The anti-slip coating 16 is provided to reduce the likelihood that a person walking on the floor tile assembly 10 will slip and fall.

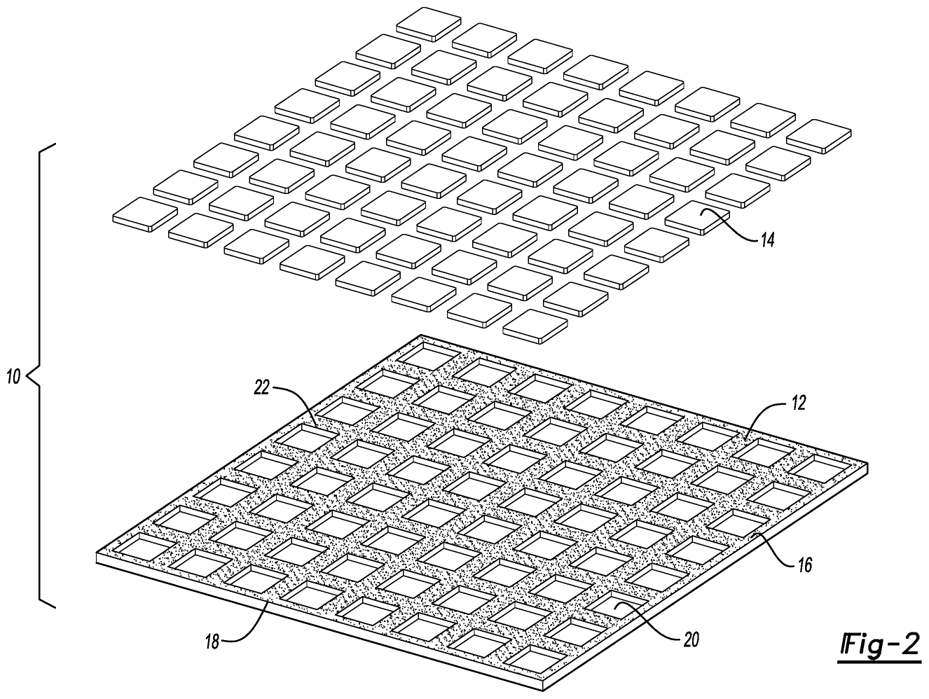

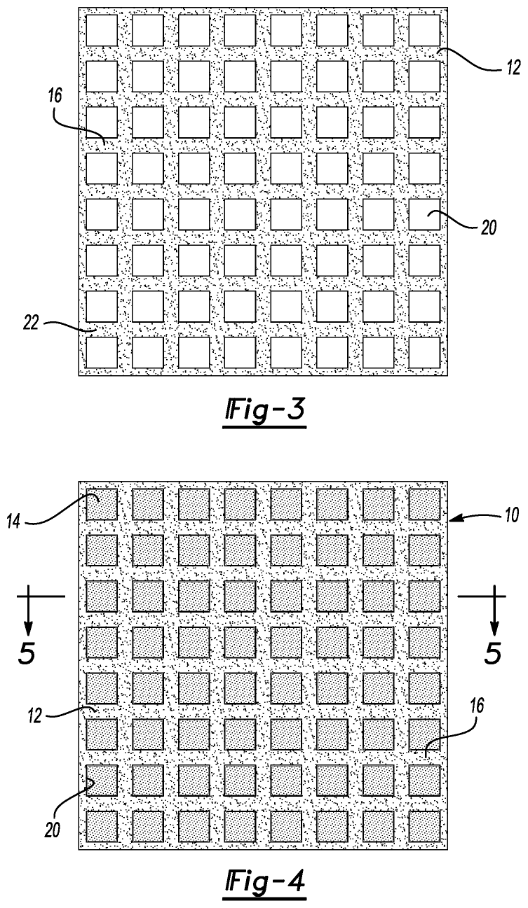

As shown in FIGS. 2 and 3, the framework 12 is preferably made of aluminum or an aluminum alloy to minimize the weight of the floor tile assembly 10. Alternatively, the framework 12 may be made of steel, stainless steel, or another metal or metal alloy. The framework 12 is stamped or otherwise formed to define a plurality of recesses 20 in the upper surface 18. The recesses 20 as shown are square, but the recesses may be rectilinear, circular, ovate, or irregular in shape depending upon the shape of the tiles 14 that are assembled to the framework 12. The recesses 20 are separated by ridges 22 formed on the upper surface 18 that are coated with the anti-slip coating 16 and is shown by stippling on the upper surface 18. The recesses 20 are each adapted to receive a tile 14.

The anti-slip coating 16 is preferably made of a stainless steel alloy to provide a surface that does not corrode and provide a hard, durable surface covering the framework 12. The stainless steel alloy is preferably applied to the upper surface 18 by spraying molten stainless steel from welding rods (not shown) in an arc-welding process onto the upper surface 18. The process is described in applicant's prior U.S. Pat. No. 5,711,118 the disclosure of which is incorporated by reference.

The tiles 14 are preferably ceramic tiles that provide a durable surface and offer flexibility in design and an aesthetically pleasing appearance. Alternatively, the tiles 14 may be made of marble, glass, wood, fiberglass, plastic, granite, or the like. The tiles 14 may be rectilinear, circular, ovate, or irregular in shape.

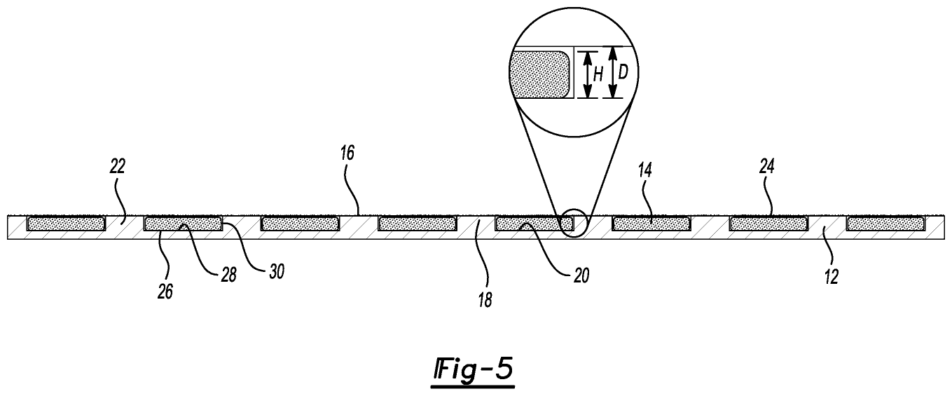

Referring to FIGS. 4 and 5, a floor tile assembly 10 is illustrated with the framework 12 coated with the anti-slip coating 16 shown with stippling and the tiles 14 shown by small dots in FIG. 4. FIG. 5 is a cross section taken through the line 5-5 in FIG. 4. The tiles 14 are shown to be disposed in the recesses 20 in FIG. 5. The anti-slip coating 16 applied to the framework 12 is above the surface of the tiles 14 to assure that a person walking on the floor tile assembly 10 will contact the anti-slip coating 16 on the ridges 22 formed between the tiles 14.

Referring to FIG. 5, the recesses 20 have a depth D and the tiles 14 have a height H that is less than D. The tiles have a top surface 24 that is recessed below the anti-slip coating 16 on the ridges 22.

The tiles 14 are secured to the framework 12 by a conventional tile adhesive (not shown) applied between the tiles 14 and the recesses 20. The adhesive is primarily applied between a bottom surface 26 of the tiles 14 and to a supporting upper surface 28 of the recesses 20. The upper surface 28 provides support for the tiles 14. Any gaps between the lateral sides 30 of the tiles and the recesses may be filled with adhesive.

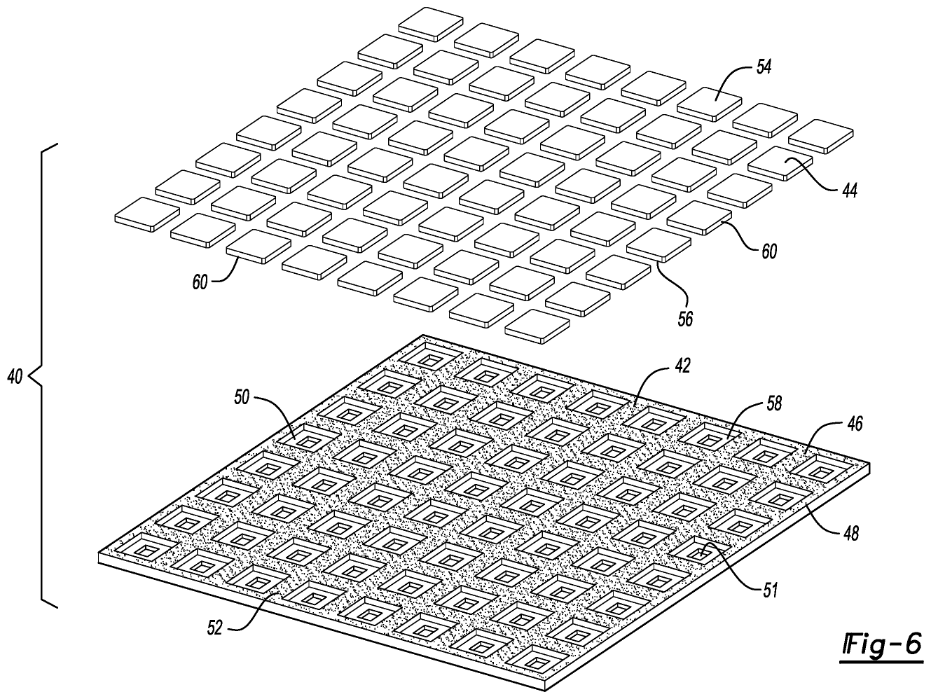

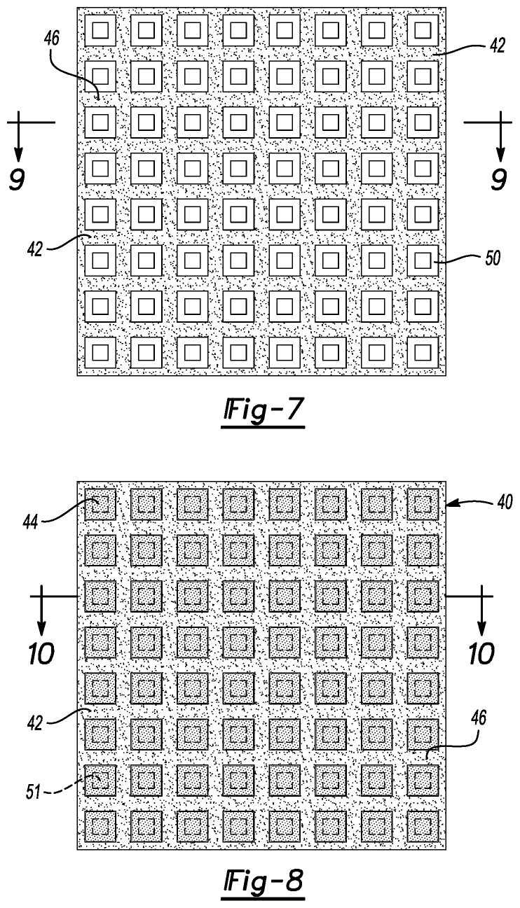

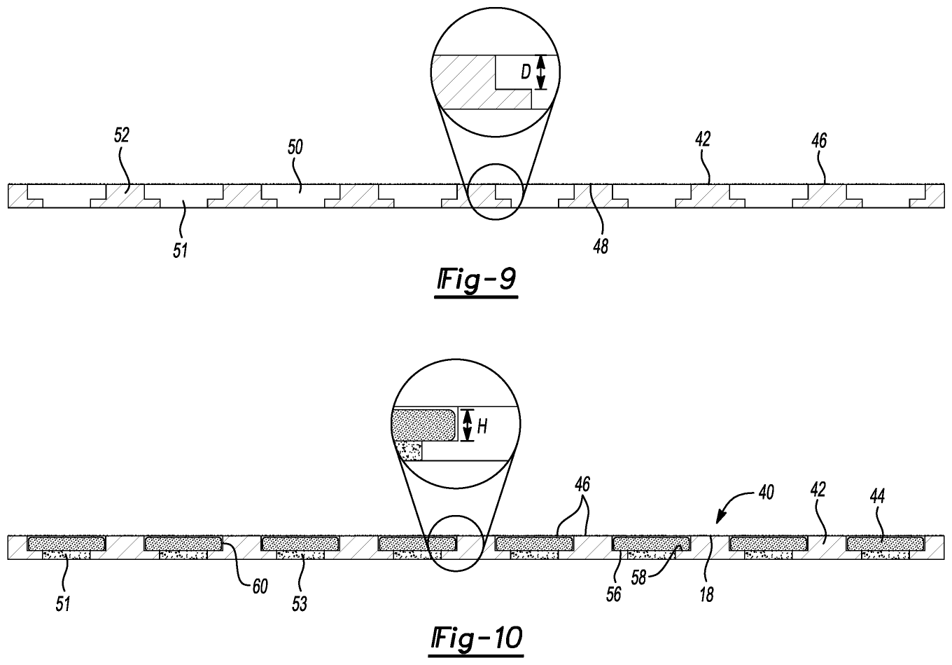

Referring to FIGS. 6-10, an alternative embodiment of a floor tile assembly 40 is illustrated that includes a framework 42 and a plurality of tiles 44. The tiles 44 are assembled to the framework 42 and permanently affixed with an adhesive (not shown) applied between the framework 42 and the tiles 44. An anti-slip coating 46 is applied to the framework by spraying molten metal on an upper surface 48 of the framework 42. The anti-slip coating 46 reduces the likelihood that a person walking on the floor tile assembly 40 will slip and fall.

As shown in FIGS. 6, 7 and 9, the framework 42 is preferably made of aluminum or an aluminum alloy to minimize the weight of the floor tile assembly 40. Alternatively, the framework 42 may be made of steel, stainless steel, or another metal or metal alloy. The framework 42 is stamped or otherwise formed to define a plurality of recesses 50 in the upper surface 48. The recesses 50 as shown are square, but the recesses may have other shapes depending upon the shape of the tiles 44 that are assembled to the framework 42. The recesses 50 are separated by ridges 52 formed on the upper surface 48 that are coated with the anti-slip coating 46 and is shown by stippling on the upper surface 48. The recesses 50 are each adapted to receive a tile 44.

In the embodiment of FIGS. 6-10, the recesses 50 define openings 51 that extend from the upper surface 58 of the recesses 50 through to the bottom of the metal framework 52. The openings 51 as illustrated are square, but the openings 51 may have other shapes and more than one opening 51 may be provided in each of the recesses 50. The openings 51 are provided to facilitate installation of the floor tile assembly 40 on a floor by receiving floor tile adhesive 53 in the openings 51 when the floor tile assembly 40 is installed.

The anti-slip coating 46 is preferably made of a stainless steel alloy to provide a surface that does not corrode and provide a hard, durable surface covering the framework 42. The stainless steel alloy is preferably applied to the upper surface 48 by spraying molten stainless steel from welding rods (not shown) in an arc-welding process onto the upper surface 48.

The tiles 44 are preferably ceramic tiles that provide a durable surface and offer flexibility in design and an aesthetically pleasing appearance. Alternatively, the tiles 44 may be made of marble, glass, wood, fiberglass, plastic, granite, or the like. The tiles 44 may be rectilinear, circular, ovate, or irregular in shape.

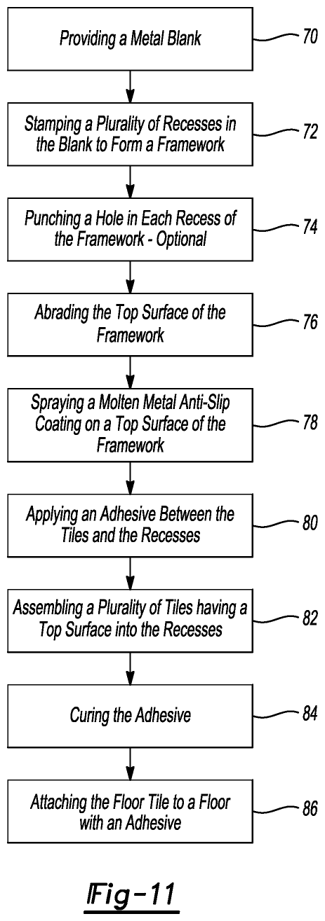

Referring to FIGS. 8 and 10, a floor tile assembly 40 is illustrated with the framework 42 coated with the anti-slip coating 46 shown with stippling and the tiles 44 shown by small dots in FIG. 4. FIG. 10 is a cross section taken through the line 10-10 in FIG. 8. The tiles 44 are shown to be disposed in the recesses 50 in FIG. 8. The anti-slip coating 46 applied to the framework 42 is above the surface of the tiles 44 to assure that a person walking on the floor tile assembly 40 will contact the anti-slip coating 46 on the ridges 52 formed between the tiles 44.

Referring to FIG. 10, the recesses 50 have a depth D and the tiles 44 have a height H that is less than D. The tiles have a top surface 54 that is recessed below the anti-slip coating 46 on the ridges 52.

The tiles 44 are secured to the framework 42 by a conventional tile adhesive (not shown) applied between the tiles 44 and the recesses 50. The adhesive is primarily applied between a bottom surface 56 of the tiles 44 and to a supporting upper surface 58 of the recesses 50. The upper surface 58 provides support for the tiles 44. Any gaps between the lateral sides 60 of the tiles and the recesses may be filled with adhesive or tile grout.

Referring to FIG. 11, a method of making the floor tile assembly of FIGS. 1-10 is illustrated by a flow chart. According to the method, a metal blank is provided at 70 that is then stamped at 72 to form the plurality of recesses 20, 50 in the frameworks 12, 42. In the embodiment of FIGS. 6-10, openings or holes 51 are punched or otherwise formed in the recesses 50, at 74. The upper surfaces 18, 48 of the framework 12, 42 is abraded at 76 to clean and roughen the upper surfaces 18, 48. At 78, a molten metal anti-slip coating is sprayed on a top, or upper, surface of the framework 12, 42. An adhesive is applied between the tiles 14, 44 and the recesses 20, 50 at 80 and the tiles 14, 44 are assembled into the recesses 20, 50 at 82. The adhesive is cured at 84 and after curing the floor tiles 10, 40 are attached to a floor with a tile adhesive at 86.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments. In addition, the features of various implementing embodiments may be combined to form further embodiments of the invention.

What is claimed is:

1. A floor tile comprising:
a metal framework defining a plurality of recesses, the plurality of recesses having a depth D, wherein the recesses are separated by a plurality of intersecting ridges, and wherein the plurality of ridges are coated with an anti-slip coating; and
a plurality of tiles each assembled into one of the plurality of recesses, wherein the tiles have a height H that is less than D, and a top surface that is recessed below the anti-slip coating.

2. The floor tile of claim 1 further comprising:
an adhesive applied between the plurality of recesses and the tiles that bonds the tiles into the recesses.

3. The floor tile of claim 1 wherein a plurality of openings are defined by at least some of the plurality of recesses that extend from a bottom surface of the metal framework to a top surface of the recesses.

4. The floor tile of claim 3 wherein an adhesive applied to the bottom surface of the metal framework is adapted to flow into the openings defined by the recesses.

5. The floor tile of claim 1 wherein the metal framework is aluminum, and the anti-slip coating is a stainless steel coating.

6. The floor tile of claim 1 wherein the ridges are rectilinear.

7. The floor tile of claim 1 wherein the ridges are curved.

8. The floor tile of claim 1 wherein the anti-slip coating is a metal coating that is flame sprayed on the plurality of intersecting ridges.

9. A method of making a floor tile comprising:
providing a metal framework defining a plurality of recesses;
applying an anti-slip coating to a plurality of ridges provided on an upper surface of the metal framework;
assembling a plurality of tiles each into one of the plurality of recesses, the tiles having a top surface; and
applying an adhesive between the tiles and the recesses in the metal framework to secure the tiles in the openings with the top surface of the tiles being recessed relative to the plurality of ridges on the upper surface of the metal framework.

10. The method of making a floor tile of claim 9 further comprising:
providing a metal framework;
stamping the plurality of recesses in the metal framework; and
forming at least one opening in at least some of the plurality of recesses of the metal framework.

11. The method of making a floor tile of claim 9 wherein the step of applying the anti-slip coating is performed by spraying a molten metal coating on the top surface of the metal framework.

12. The method of making a floor tile of claim 9 wherein the metal framework is aluminum.

13. The method of making a floor tile of claim 9 wherein the anti-slip coating is stainless steel.

14. A floor tile comprising:
a metal tile support panel having a top surface including a plurality of ridges, wherein the plurality of ridges in the top surface are coated with an anti-slip coating; and
a plurality of tiles attached to the metal tile support panel between the plurality of ridges, wherein the tiles have an upper surface that is recessed below the top surface of the ridges in an installation orientation.

15. The floor tile of claim 14 wherein the plurality of tiles are selected from the group consisting of:
ceramic tiles;
glass tiles;
marble tiles;
wood tiles; and
granite tiles.

16. The floor tile of claim 14 wherein the metal tile support panel is aluminum, and the anti-slip coating is stainless steel.

17. The floor tile of claim 14 wherein the plurality of tiles is attached to the metal tile support panel by an adhesive.

18. The floor tile of claim 14 wherein the metal tile support panel defines openings that extend from a bottom surface of the metal tile support panel to the top surface between the plurality of ridges and below the tiles.
